(19) United States
(12) Patent Application Publication
(10) Pub. No.: US 2007/0178296 A1
(43) Pub. Date: Aug. 2, 2007

(54) Lubricating surface having numerous protrusions

(75) Inventor: Fred N. Miekka, Arcadia, CA (US)

Correspondence Address: FRANK A. PALASE, SUITE 203, 141 E. HUNTINGTON DRIVE, ARCADIA, CA, 91006, US

(73) Assignee: SIERRA MADRE MARKETING GROUP

(21) Appl. No.: 11/700,929

(22) Filed: Feb. 1, 2007

Related U.S. Application Data
(60) Provisional application No. 60/764,088, filed on Feb. 1, 2006.

(51) Int. Cl. B32B 3/26

(52) U.S. Cl. 428/305.5; 428/409; 428/318.4

(57) ABSTRACT

Lubricating surfaces are disclosed suitable for sliding against other flat surfaces. These lubricating surfaces consist of multiple protrusions extending outward from the surface and employ solid or semi-solid lubricants such as grease between them. The resulting lubricating surfaces may be used in numerous applications and may be particularly useful for sliding surfaces used on a continuous or on an intermittent basis.

### CROSS-REFERENCE TO RELATED APPLICATIONS

This non-provisional application claims benefit of the provisional application filed on Feb. 1, 2006 having application number U.S. 60/764,088.

### BACKGROUND OF THE INVENTION

1. Field of the Invention

This invention relates to lubricating surfaces and more particularly to lubricating surfaces suitable for sliding against hard flat surfaces.

2. Description of the Related Art

There are numerous methods that may be employed to reduce friction between sliding and/or rotating surfaces. One of the easiest methods is to apply a lubricant between the intended surfaces. A lubricant is a material that reduced friction between the contacting surfaces of moving parts by providing a thin film barrier. One of the more common lubricants is oil. Oils are liquid materials that do not dissolve in water and tend to have low surface free energies. Such materials may be selected from various chemical groups including petroleum hydrocarbons, fatty acid esters, and silicone polymers such as polydimethylsiloxane.

The importance of lubricating moving parts becomes rather evident in the case of internal combustion engines. Internal combustion engines are heat engines that derive their power from burning a fuel air mixture inside of a combustion chamber. Examples of internal combustion engines include diesel engines and gasoline engines.

Internal combustion engines require constant lubrication for their smooth operation. Oil is normally supplied in the sump portion of the engine and is sprayed throughout the interior during running. An internal combustion engine running without lubricating oils will fail in a relatively short time often resulting in permanent damage. Thus the numerous sliding and rotating parts of internal combustion engines require constant lubrication.

Internal combustion engines often employ ball bearings as part of their assemblies. Ball bearings provide rolling surfaces and therefore reduce the effects of sliding. It should be noted that ball bearings have some inherent friction and therefore require a lubricant such as oil or grease.

Sliding friction surfaces for rotating parts are well known art. A good example is the sintered bronze bushing. Sintered bronze bushings are porous soft metal bushings saturated with an oil based lubricant. These bushings provide a constant supply of lubricant due to their porous nature. Care needs to be exercised with the use of these bushings not to allow them to dry out of lubricant and not to exceed their load characteristics. Due to the sliding nature of sintered bronze bushings he load characteristics may be significantly less than that of ball bearings.

There are numerous sliding conditions between surfaces where short distances of relatively small force occurs on a relatively infrequent basis. For example, Sliding glass doors are opened and closed on occasion and therefore are not exposed to continuous sliding friction. Because of this it is often practice to have a hard piece of plastic act as a solid lubricant between the bottom of the door and the track. While being effective at first, it is often the case that such solid sliding plastic pieces collect dirt, scratch metal surfaces such as aluminum and increase their coefficient of friction after repeated use. The result is a sliding door that becomes increasingly difficult to open and close.

There is thus a need for a sliding lubricating surface suitable for intermittent or even continuous use that is low in cost and can maintain its integrity over a prolonged period of time.

It is an object of this invention to provide a lubricating surface suitable for sliding surfaces.

It is a further object of this invention to provide a lubricating surface that is low in cost.

It is a further object of this invention to provide a sliding lubricating surface that maintains a low coefficient of friction over prolonged use.

It is a further object of this invention to provide a sliding lubricating surface requiring little to no maintenance.

Finally it is an object of this invention to provide a sliding lubricating surface for use on numerous surfaces.

This invention therefore proposes a low coefficient of friction sliding lubricating surface consisting of surface protrusions of a solid material such as metal having a solid or semi-solid lubricant filling in the spaces between solid surface protrusions.

### SUMMARY OF THE INVENTION

In summary this invention provides low coefficient of friction lubricating surfaces suitable for use against numerous other surfaces. Lubrication is provided by a solid or semi-solid lubricant such as grease. Wear resistance is provided by protrusions of a solid material of greater hardness than the lubricant. The numerous protrusions provide wear resistance while at the same time holding the lubricant between them.

### BRIEF DESCRIPTION OF THE DRAWINGS

FIG. 1 shows a lubricating surface of this invention.

FIG. 2 shows a rectangular assembly consisting of a lubricating surface fixedly attached to a solid bottom portion.

FIG. 3 shows a circular assembly consisting of a lubricating surface fixedly attached to a solid bottom portion.

FIG. 4 shows a cross sectional view of a lubricating surface assembly.

FIG. 5 shows a cross sectional view of a lubricating surface assembly having protrusions with flattened tops.

FIG. 6 shows a cross sectional view of a lubricating surface assembly having protrusions with flattened tops up against another surface.

### DESCRIPTION OF THE INVENTION

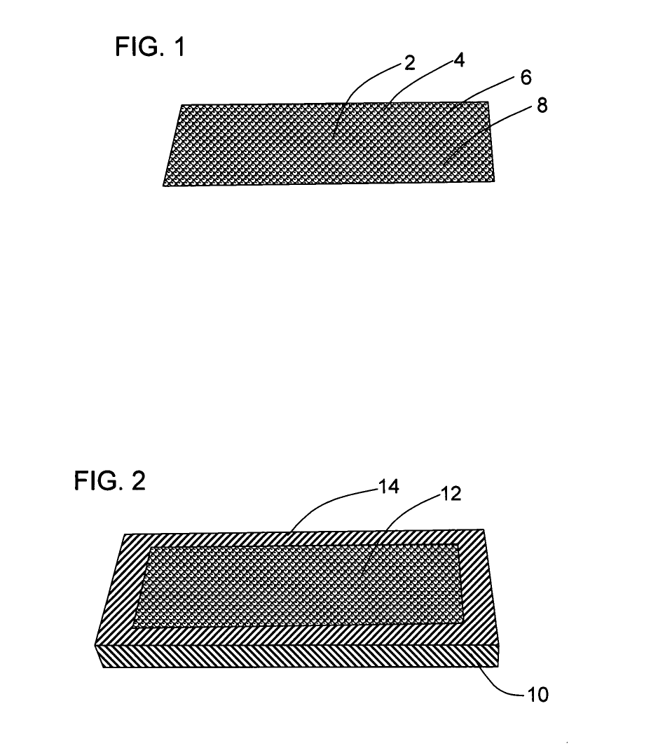

FIG. 1 shows a lubricating surface of this invention. Lubricating surface 2 consists of surface protrusions 4 and liquid, solid, or semi-solid lubricating agent 6 dispersed within cavities 8 between surface protrusions 4. Surface protrusions 4 are shown extending in an outward direction. Numerous methods may be used to provide numerous surface protrusions. An example of this may be found in U.S. Pat. No. 6,692,813 awarded to Allen Elder titled “Multilayer Spherical Bonding Construction” included herein by reference. In particular, the lost wax process is disclosed as one method for forming surfaces having numerous spherical protrusions extending in an outward direction. U.S. Pat. No. 6,692,813 employs cavities formed between spherical protrusions for interlocking with bonding agents. Surface protrusions 4 may be spherical or substantially spherical in shape. Substantially spherical may be used to describe protrusions having a general shape that is about 50% or more spherical. Such shapes include hemispheres and the like.

FIG. 2 shows a rectangular assembly 10 consisting of lubricating surface 12 fixedly attached to top surface portion 14.

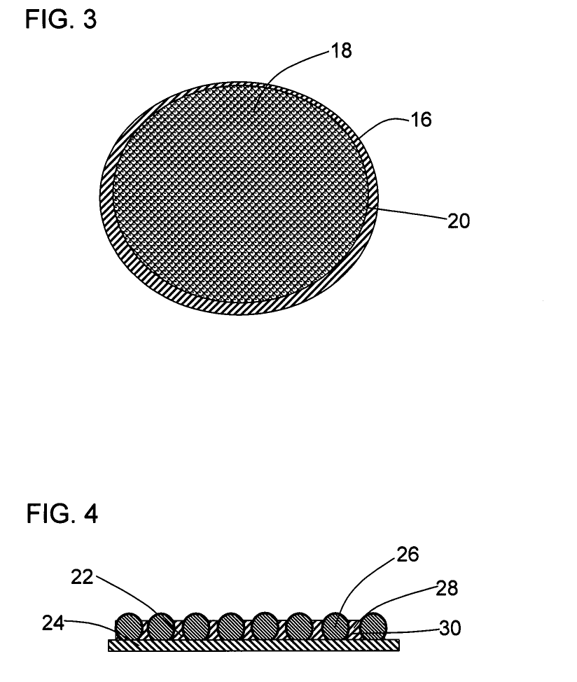

FIG. 3 shows a circular assembly 16 consisting of lubricating surface 18 fixedly attached to top surface portion 20.

FIG. 4 is a cross sectional view of a lubricating surface assembly. Lubricating surface assembly 22 consists of bottom solid portion 24 and protrusions 26. Also shown is lubricant 28 located in spaces 30 between protrusions 26.

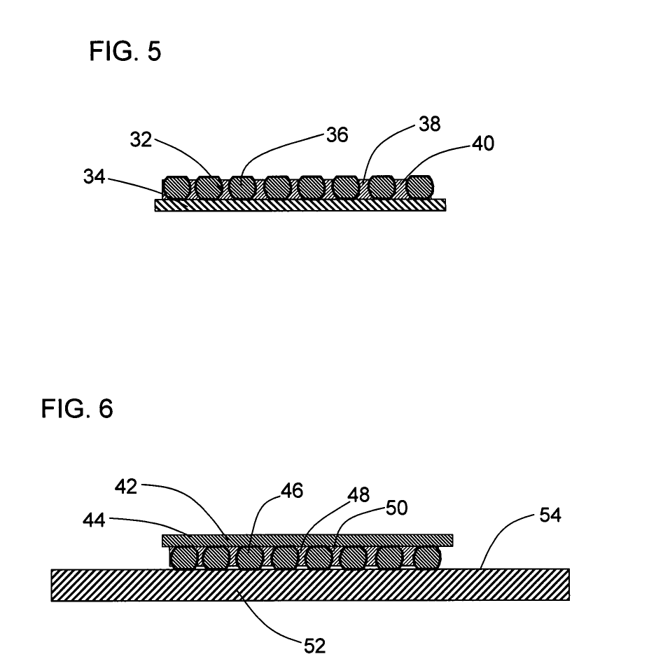

FIG. 5 shows a cross sectional view of a lubricating surface assembly having protrusions with flattened tops. Lubricating surface assembly 32 consists of bottom solid portion 34 and protrusions 36. Protrusions 36 have flattened tops and therefore have a greater area of surface contact than rounded protrusions 26 of FIG. 4. Also shown is lubricant 38 located in spaces 40 between protrusions 36.

FIG. 6 shows a cross sectional view of a lubricating surface assembly having a plurality of protrusions with flattened tops up against another surface. Lubricating surface assembly 42 consists of top solid portion 44 and protrusions 46. Protrusions 46 are shown extending in an outward direction from bottom surface 56 of top solid portion 44. Protrusions 46 have flattened tops and therefore have a greater area of surface contact than rounded protrusions 26 of FIG. 4. Also shown is lubricating agent 48 located in cavities 50 between protrusions 46. Lubricating agent 48 may be a liquid such as oil, or alternatively, lubricating agent 48 may be comprised of a semi-solid such as grease. Lubricating agent 48 is shown dispersed within cavities 50 formed by protrusions 46. Also shown is bottom portion 52. Also shown is top surface portion 54 of bottom portion 52. Bottom portion 52 may be made from any number of materials. Lubricating surface assembly 42 is shown providing lubricating properties to top surface 54.

Those skilled in the art will understand that the preceding exemplary embodiments of the present invention provide foundation for numerous alternatives and modifications. These other modifications are also within the scope of the limiting technology of the present invention. Accordingly, the present invention is not limited to that precisely shown and described herein but only to that outlined in the appended claims.

What is claimed is:

1. A lubricating surface assembly comprising:
a top solid portion, and a lubricating agent;
said top solid portion having a bottom surface;
said bottom surface of said solid top solid portion having a plurality of protrusions extending from said bottom surface in an outward direction forming one or more cavities; and;
said lubricating agent dispersed within said cavities of said bottom surface of said top solid portion thereby providing lubricating properties to other surfaces.

2. A lubricating surface assembly as recited in claim 1 wherein said protrusions are substantially spherical.

3. A lubricating surface assembly as recited in claim 1 wherein said protrusions have flat top geometry.

4. A lubricating surface assembly as recited in claim 2 wherein said protrusions have flat top geometry.
